(19) United States
(12) Patent Application Publication
(10) Pub. No.: US 2017/0372550 A1
(43) Pub. Date: Dec. 28, 2017

(54) WIRELESS DOOR LOCK SYSTEM WITH AN EMERGENCY REPORTING FUNCTION AND METHOD FOR OPERATING THE SAME

(71) Applicant: INSYDE SOFTWARE CORP., Taipei City (TW)

(72) Inventor: Wen-Ming LIN, Taipei City (TW)

(73) Assignee: INSYDE SOFTWARE CORP., Taipei City (TW)

(21) Appl. No.: 15/581,157

(22) Filed: Apr. 28, 2017

(30) Foreign Application Priority Data
Jun. 24, 2016 (TW) 105119853

(51) Int. Cl. G07C 9/00; G08B 13/22; H04L 29/08; G08B 29/18; H04W 4/22; H04W 4/00

(52) U.S. Cl. CPC G07C 9/00309; H04W 4/22; H04W 4/008; H04L 67/26; G08B 29/185; G08B 13/22; G07C 2009/00769

(57) ABSTRACT

A wireless door lock system with an emergency reporting function includes a user device, a door lock device, a network server and at least one recipient device. When the user device transmits a request signal for reporting an emergency condition to the door lock device, the door lock device determines if the user device is a paired device of the door lock device according to the request signal and further sends an emergency condition confirmation signal to the user device by way of wireless communication. The user device is then connected to the network server through the Internet and transmits an emergency condition signal to activate the network server to perform a push notification service and send an emergency condition message to the at least one recipient device. Given the push notification, the emergency condition message can be instantly provided to right recipients for emergency condition notification.

### BACKGROUND OF THE INVENTION

### 1. Field of the Invention

The present invention relates to a wireless door lock system and a method for operating the same and, more particularly, to a wireless door lock system with an emergency reporting function and a method for operating the same.

### 2. Description of the Related Art

Widespread mobile devices have made smart phones, tablet computers, and the like become daily necessity into the household. Given smart phones as an example, besides making telephone calls, smart phones have more and more features embedded therein to make them very powerful these days.

There are chances that inconvenience arises when people have to seek through their pockets or backpacks to find the keys to open or lock their household door locks. To tackle such an issue, wireless door locks and mobile devices with features of locking and unlocking door have brought into play as one of the solutions. However, as far as emergency reporting is concerned, applications combining mobile devices and wireless door locks are not quite mature yet.

In the case of developing wireless door locks with an emergency reporting function, it is common for users of the door locks to perform emergency reporting operation on a wireless door lock through a mobile device, such as a smart phone. The smart phone is used to send an alert control signal to the wireless door lock. When receiving the alert control signal, the wireless door lock immediately reports an emergency condition. As the wireless door lock does not authenticate the identity of the mobile device to determine if the mobile device is a paired device of the wireless door lock, any other mobile device capable of activating the emergency reporting function of the wireless door lock can also control the wireless door lock for emergency reporting. As a consequence, the wireless door lock may generate false emergency report, which bothers people who receive the false emergency report or seriously causes delay in taking immediate actions to respond to the emergency.

### SUMMARY OF THE INVENTION

An objective of the present invention is to provide a wireless door lock system with an emergency reporting function and a method for operating the same, which target at preventing non-paired mobile devices capable of accessing the emergency report function of the door lock device from operating the door lock device and making false emergency condition notification under the circumstance that identification authentication of paired device is not available. To achieve the foregoing objective, the wireless door lock system with an emergency reporting function includes a user device, a door lock device, a network server and at least one recipient device.

The user device has a wireless data transceiving function and a wireless network connection function.

The door lock device has the wireless data transceiving function.

The at least one recipient device has the wireless network connection function and is connected to the network server through the Internet.

When the user device transmits a request signal for reporting an emergency condition to the door lock device by way of wireless communication, the door lock device determines if the user device is a paired device thereof according to the request signal and then sends an emergency condition confirmation signal to the user device, and after receiving the emergency condition confirmation signal, the user device is connected to the network server through the Internet and transmits an emergency condition signal to the network server for the network server to perform a push notification server to send an emergency notification message to the at least one recipient device.

To achieve the foregoing objective, a wireless door lock system with an emergency reporting function performs an application on a user device, communicates with a door lock device with a wireless transceiving function by way of Bluetooth® communication, and is connected to a network server through the Internet for the network server to perform a push notification service to send an emergency notification message to at least one recipient device, and the method for operating the wireless door lock system includes steps of:

sending a request signal for reporting an emergency condition from the user device to the door lock device;

after the door lock device receives the request signal, determining if the user device is a preset paired device of the door lock device according to the request signal;

sending an emergency condition confirmation signal from the door lock device to the user device when the door lock device determines that the user device is a paired device of the door lock device;

after the user device receives the emergency condition confirmation signal, making connection to the network server through the Internet and sending out an emergency condition signal; and

after the network server receives the emergency condition signal, performing a push notification service to send an emergency condition notification to the at least one preset recipient device.

Given the foregoing wireless door lock system with an emergency reporting function and the method for operating the same, the door lock device transmits the emergency condition confirmation signal to the user device by way of wireless communication, and determines if the user device is a paired device thereof according to the encrypted identification authentication information contained in the request signal for reporting an emergency condition, thereby achieving the purpose of authenticating identification of the user device and preventing non-paired device from operating the emergency reporting function.

Other objectives, advantages and novel features of the invention will become more apparent from the following detailed description when taken in conjunction with the accompanying drawings.

### BRIEF DESCRIPTION OF THE DRAWINGS

FIG. 1 is a first embodiment of a wireless door lock system with an emergency reporting function in accordance with the present invention;

FIG. 2 is a schematic view showing a user interface of an application running on a user device of the wireless door lock system in FIG. 1;

FIG. 3 is a schematic view showing a recipient device of the wireless door lock system receiving an emergency condition notification;

FIG. 4 is a sequence diagram showing operation of the wireless door lock system in FIG. 1;

FIG. 5 is a second embodiment of a wireless door lock system with an emergency reporting function in accordance with the present invention;

FIG. 6 is a sequence diagram showing operation of the wireless door lock system in FIG. 5;

FIG. 7 is a third embodiment of a wireless door lock system with an emergency reporting function in accordance with the present invention;

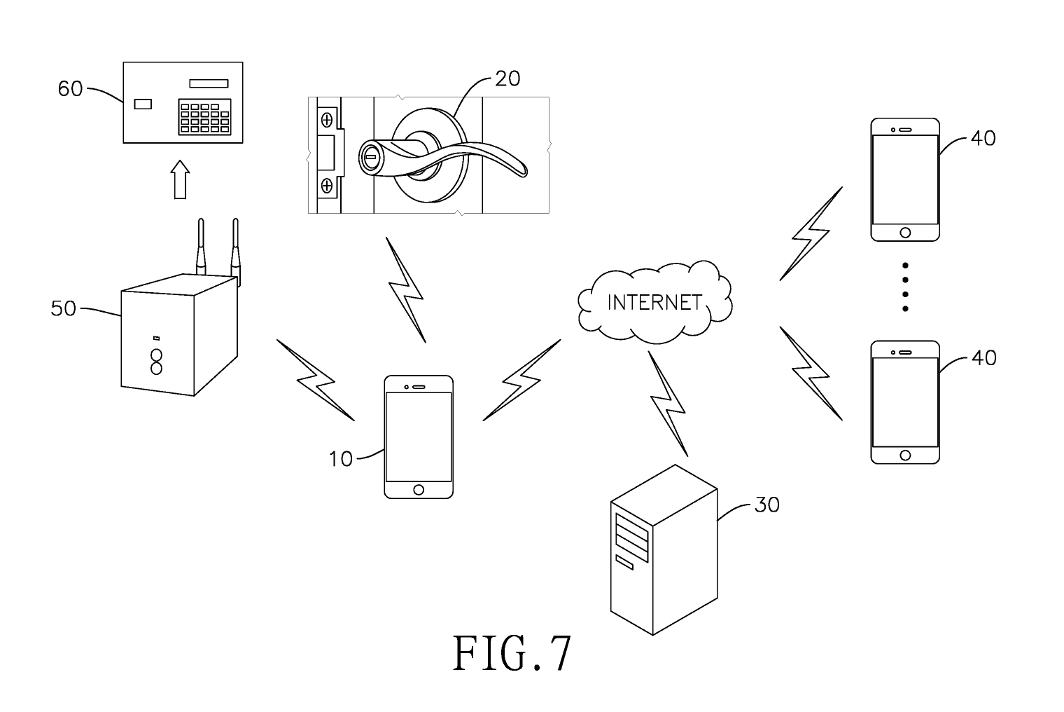

FIG. 8 is a sequence diagram showing operation of the wireless door lock system in FIG. 7;

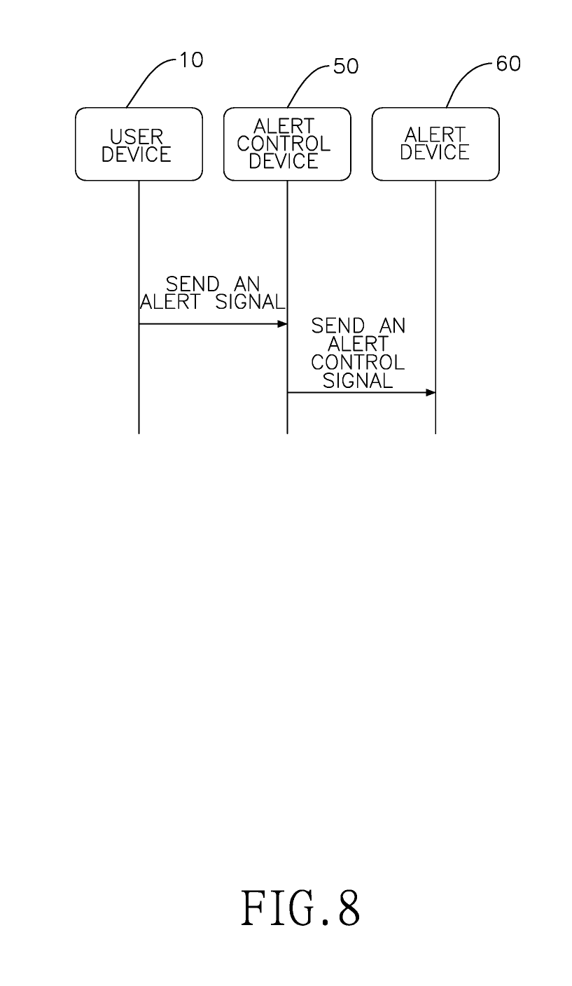

FIG. 9 is a flow diagram of a method for operating a wireless door lock system in accordance with the present invention;

FIG. 10 is a flow diagram of an embodiment of step S30 of the method in FIG. 9; and

FIG. 11 is a flow diagram of another embodiment of step S30 of the method in FIG. 9.

### DETAILED DESCRIPTION OF THE INVENTION

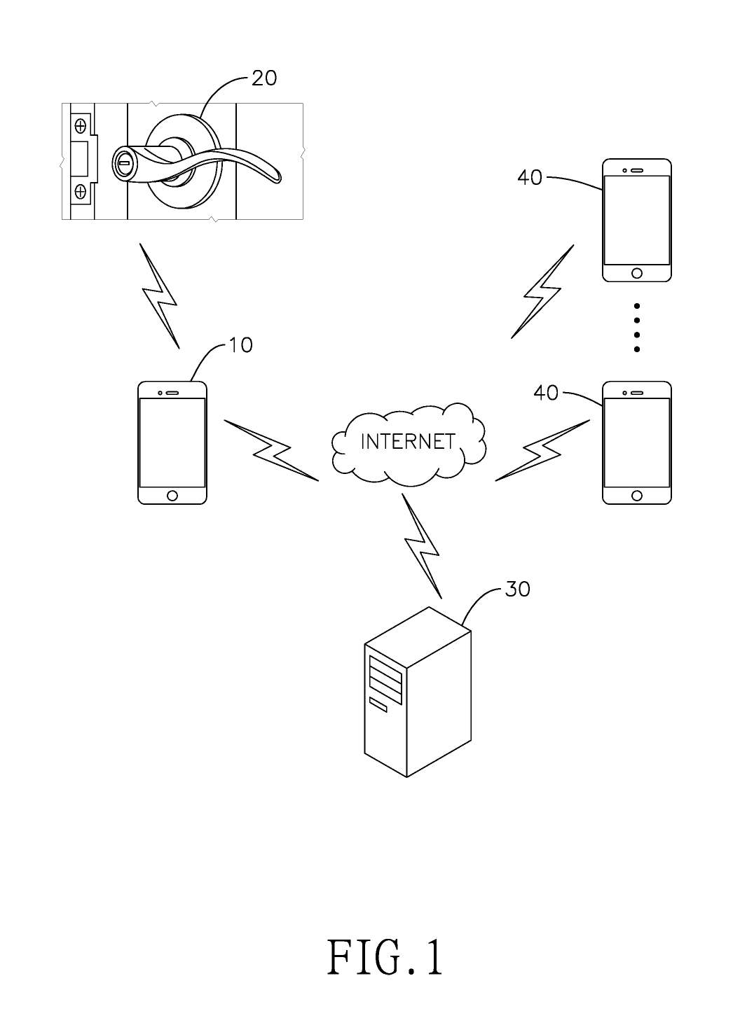

With reference to FIG. 1, a first embodiment of a wireless door lock system with an emergency reporting function in accordance with the present invention includes a user device 10, a door lock device 20, a network server 30, and at least one recipient device 40. The user device 10 is portable, has functions of Bluetooth® data transceiving and wireless network connection, and may be a smart phone or a tablet computer. The wireless data transceiving function may be implemented by a Bluetooth® transceiver module built in the user device 10. The wireless network connection function of the user device 10 may be implemented by a wireless networking module built in the user device 10 in compliance with communication standards, such as Wi-Fi (Wireless Fidelity), ZigBee, 3G, 3.5G, 4G or higher mobile communication standard.

The door lock device 20 is mounted on a door at home of a user who is in possession of the user device 10, and has the wireless data transceiving function, which is implemented by a Bluetooth® transceiver module built in the door lock device 20.

The network server 30 is a remote server in connection with an internal device or equipment through the Internet. The at least one recipient device 40 has the wireless network connection function, and is connected to the network server 30 through the Internet. The at least one recipient device 40 may include but is not limited to a personal computer, a notebook computer, a smart phone, a tablet computer, and the like, as long as the wireless network connection capability is provided. The wireless network connection function of the at least one recipient device 40 may be implemented by a wireless networking module built in each one of the at least one recipient device 40 in compliance with communication standards, such as Wi-Fi (Wireless Fidelity), ZigBee, 3G, 3.5G, 4G or higher mobile communication standard.

In the present embodiment, the at least one recipient device 40 is designated as the devices receiving emergency condition notifications when the user of the user device 10 encounters an emergency. As an example of a child who has the user device 10, at least one owner of the at least recipient device 40 may be designated as father, mother, school teacher, neighbor, and the like. Thus, when the child encounters an emergency, the at least one recipient device 40 of the at least one designated owner will receive emergency condition notifications. A unique device identification corresponding to each one of the at least one recipient device 40 of the at least one designated owner is stored in the network server 30 to configure the recipient device 40 with the device identification as a device which receives emergency condition notifications, such that when the network server 30 receives a push notification request for emergency reporting from the user device 10, the network server 30 performs the push notification service to send the emergency condition notifications to the recipient device 40 with the device identification.

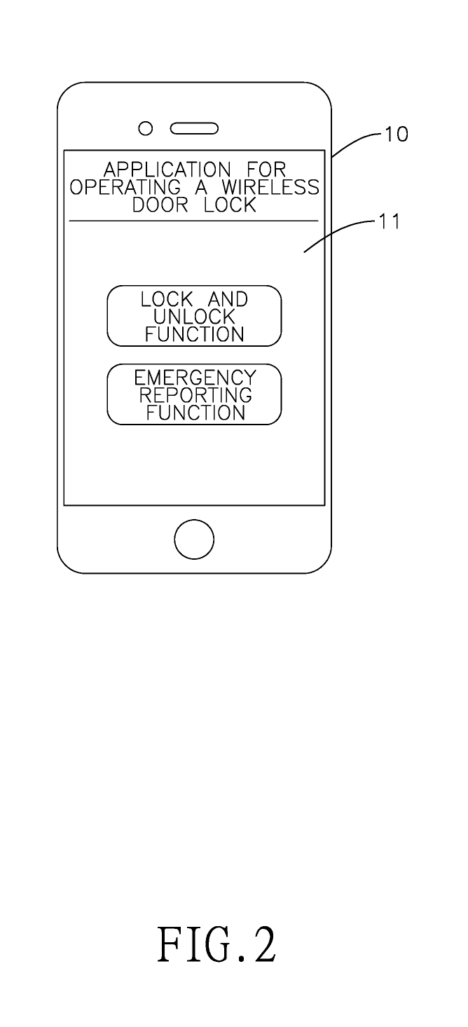

With reference to FIG. 2, the user device 10 may download an application (APP) associated with Bluetooth® door lock operation, and the user of the user device 10 can open and lock a household door and perform the emergency reporting function upon an emergency by launching the APP. When the user launches the APP through the user device 10, a user interface 11 is generated on a display screen of the user device 10 with a lock/unlock function and an emergency reporting function displayed on the user interface 11. Under normal circumstance, the user can select the choice of the lock/unlock function on the user interface 11 to lock or unlock a household door. In case of an emergency, the user can select the choice of the emergency reporting function on the user interface 11 to perform emergency reporting for further actions. The choice of the emergency reporting function displayed on the user interface 11 is just an example and should not be taken as a limitation. The user can also perform emergency reporting by continuously pressing a specific physical button or a virtual item.

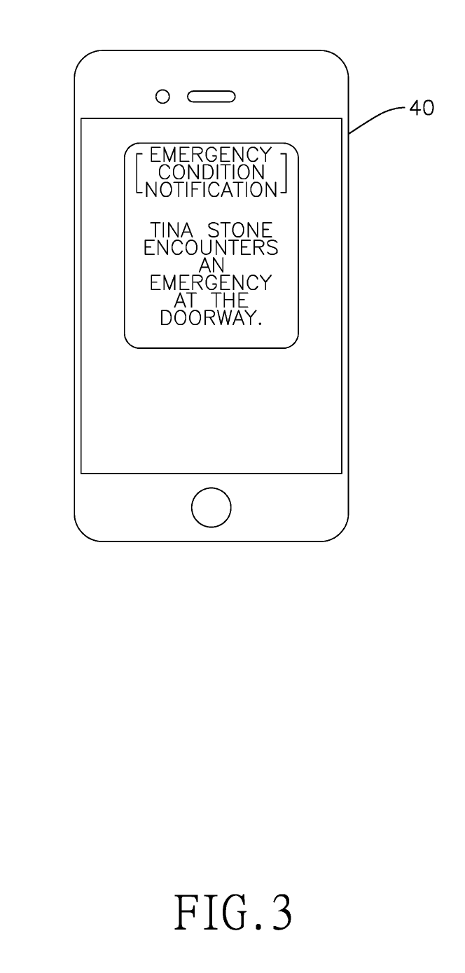

With reference to FIG. 3, when the user of the user device 10 activates the emergency reporting function, the recipient device 40 designated beforehand will receive a push message relevant to the emergency condition notification. Therefore, the owner of the designated recipient device 40 can be instantly aware of the emergency condition that the user of the user device 10 encounters, allowing fastest actions to be taken in response to the emergency condition.

The following scenario taking place in daily life can be taken as an example for explanation. Suppose that a girl owns the user device 10, and father, mother and a school teacher are preliminarily designated as the owners of the recipient devices 40. As the girl constantly feels that someone is stalking her on her way home one day after school, when the girl returns home and approaches a door having the door lock device 20 mounted thereto within an effective detection range, approximately 10 meters in the case of the wireless transceiver module, if the girl realizes that the intention of stalking is still there and there is a likelihood of criminal attempt from that someone, she can launch the APP associated with wireless door lock operation on the user device 10 and select the emergency reporting function or continuously press the specific physical button to activate the emergency reporting function.

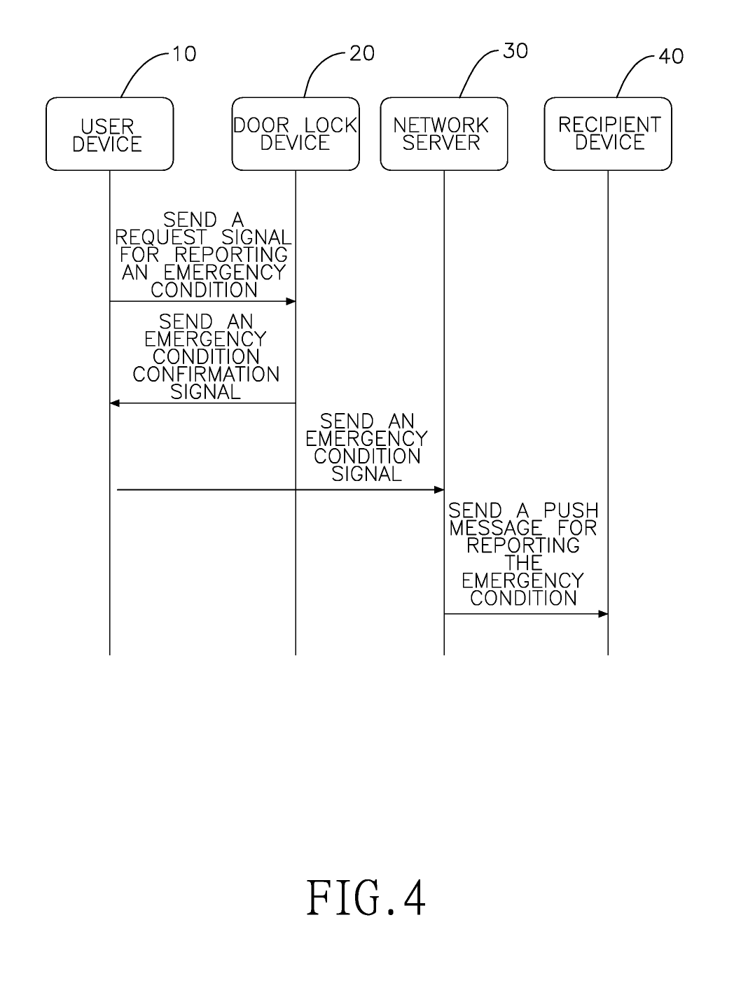

With reference to FIGS. 1 and 4, after the girl activates the emergency reporting function, the user device 10 sends out the request signal for reporting an emergency condition by virtue of wireless communication, and the door lock device located within an effective detection range receives the request signal and transmits an emergency condition confirmation signal to the user device 10 by virtue of wireless communication to determine that the user device 10 and the door lock device 20 are paired devices. Specifically, encrypted identification authentication information of the user device 10 is contained in the request signal, such that when the door lock device 20 receives the request signal and further determines whether the encrypted identification authentication information in the request signal matches that of a paired device. When determining that the user device 10 is a correct paired device, the door lock device 20 issues the emergency condition confirmation signal to the user device 10 to confirm that the user device 10 and the door lock device 20 are paired devices. On the other hand, when determining that the user device 10 is not a correct paired device, the door lock device 20 issues no emergency condition confirmation signal to the user device 10. Hence, the wireless door lock system with an emergency reporting function in accordance with the present invention also provides a function of authenticating the user device 10. The door lock device 20 returns the emergency condition confirmation signal to the user device 10 only when determining that the request signal is transmitted from a paired user device 10, so as to complete the authentication done by the door lock device 20 and prevent users of non-paired devices from operating the emergency reporting function.

After the user device 10 receives the emergency condition confirmation signal from the door lock device 20 in completion of identification authentication for device pairing, the user device 10 is connected to the network server 30 through the Internet and issues an emergency condition signal. After receiving the emergency condition signal, the network server 30 performs a push notification service to send an emergency condition message to the recipient device(s) 40 designated beforehand. The push notification service provided by the network server 30 may be one of Google Cloud Messaging (GCM), Apple Push Notification Service (APNs), Microsoft Push Notification Service (MPNs), or any push notification server developed by technical personnel.

The emergency condition message may be preset text information, for example, as shown in FIG. 3 or a form of display with audio and visual effects on the personal computer, notebook computer, smart phone or tablet computer of the girl's father, mother, or school teacher for them to instantly acquire the emergency condition message and take immediate action, so that the emergency condition can be obviated, the harm out of the emergency condition can be kept to a minimum, and the life safety protection of the kid can be ensured.

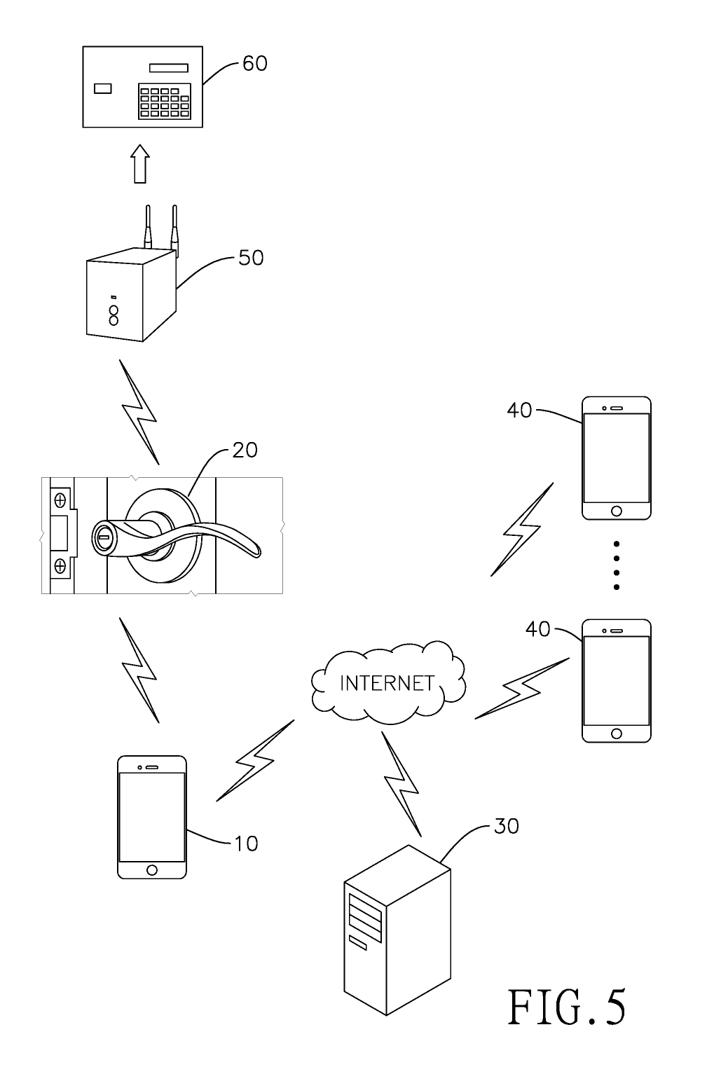

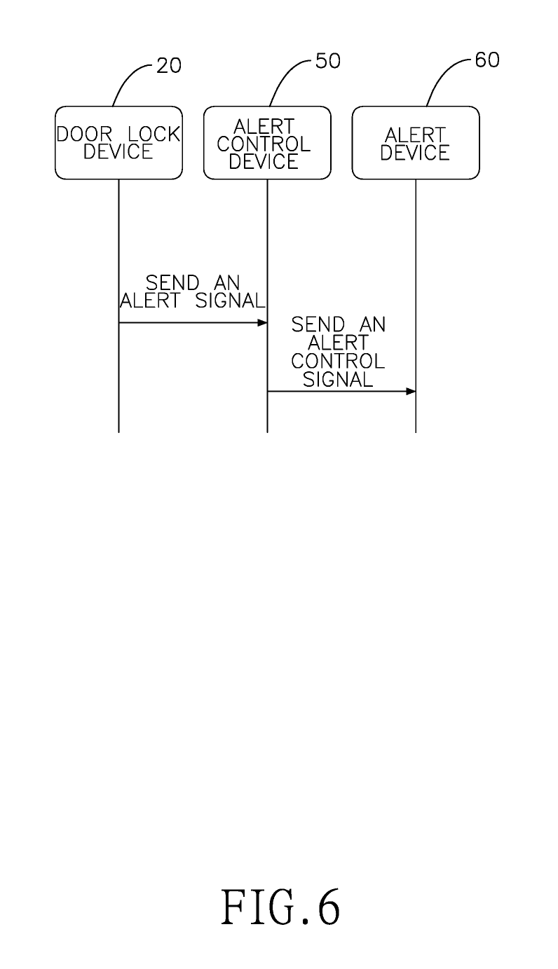

With reference to FIGS. 5 and 6, a second embodiment of a wireless door lock system in accordance with the present invention differs from the foregoing embodiment in further including an alert control device 50 and at least one alert device 60. The alert control device 50 is connected to the door lock device 20 by virtue of wireless communication. The at least one alert device 60 is connected to the alert control device 50 by a wireless or wired means and may include but is not limited to one or a combination of an alert lamp, a security server and a monitor as the measure of providing alert indication of emergency condition, security communication, surveillance, evidence collection and the like.

After the door lock device 20 transmits the emergency condition confirmation signal to the user device 10 to complete identification authentication for pairing with the user device 10, the door lock device 20 further sends an alert signal to the alert control device 50. After receiving the alert signal, the alert control device 50 sends at least one alert control signal to activate the at least one alert device 60. The at least one alert control signal corresponds to one of a wireless or wired means for the at least one alert device 60 to be connected to and controlled by the at least one alert device 60. Thus, while the at least one recipient device 40 receives the emergency condition notification, the alert lamp, the security server or the monitor can be activated at the same time to handle the emergency condition in a more efficient, broadly covered and multi-faceted manner.

The wireless door lock system with an emergency reporting function is not necessarily operated outside the household door. When the user encounters an emergency condition inside the house, such as elders' indisposition, as dialing a phone call or operating communication equipment may be a challenge to elders, elders can use the wireless door lock system with an emergency reporting function to readily press the specific physical button on the user device 10 to activate the emergency reporting function, such that nursing workers or elders' family can rapidly get the hold of the emergency situation and take immediate action.

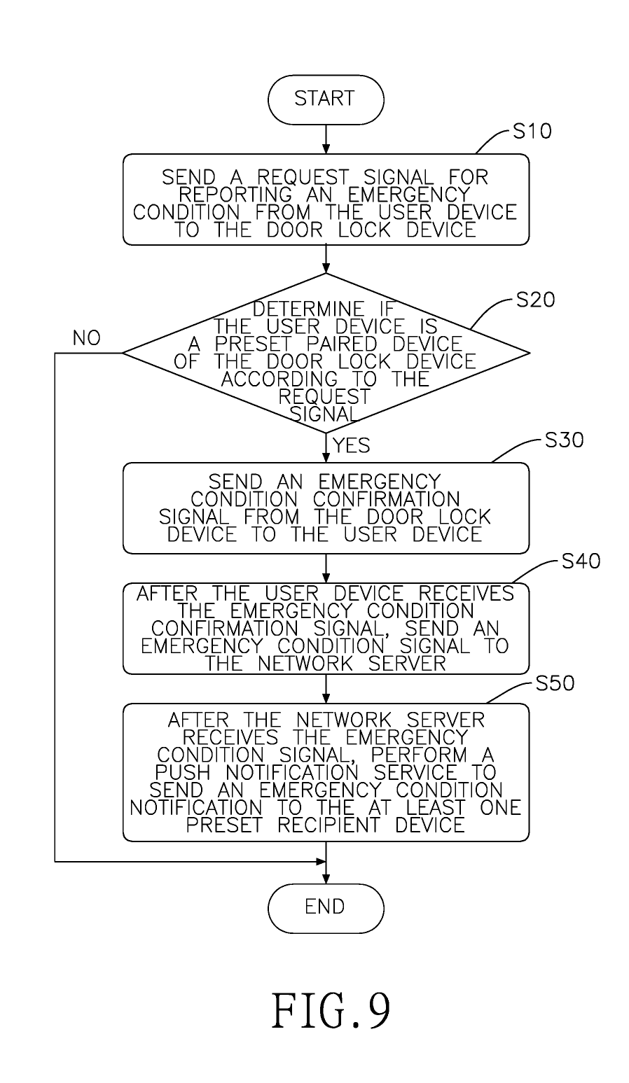

With reference to FIG. 9, a method for operating a wireless door lock system with an emergency reporting function in accordance with the present invention includes the following steps.

Step S10: The user device 10 sends a request signal for reporting an emergency condition to the door lock device 20. When the user selects the emergency reporting function on the application (APP) associated with Bluetooth® door lock operation running on the user device 10 or continuously presses the physical button on the user device 10, the user device 10 transmits the request signal for reporting an emergency condition to the door lock device 20 by virtue of Bluetooth® communication.

Step S20: The door lock device 20 determines if the user device 10 is a preset paired device according to the request signal for reporting an emergency condition after receiving the request signal. If the user device 10 is not a paired device, terminate the process of the method. Otherwise, perform step S30.

Step S30: The door lock device sends an emergency condition confirmation signal to the user device 10 by virtue of wireless communication to confirm that the user device 10 is a paired device of the door lock device 20. The request signal for reporting an emergency condition contains encrypted identification authentication information of the user device 10. The door lock device 20 determines if the user device 10 is a paired device according to the encrypted identification authentication information.

Step S40: After the door lock device 20 transmits the emergency condition confirmation signal to the user device 10 to confirm that the user device 10 is a preset paired device of the door lock device 20, the user device 10 is connected to the network server 30 through the Internet and sends out an emergency condition signal to the network server 30.

Step S50: After receiving the emergency condition signal, the network server 30 performs a push notification service to send an emergency condition notification to preset recipient device(s) 40. Hence, the foregoing method allows owners of the recipient devices 40 to instantly acquire the emergency condition message and take immediate action, so that the emergency condition can be obviated, the harm out of the emergency condition can be kept to a minimum, and the life safety protection of the users can be ensured.

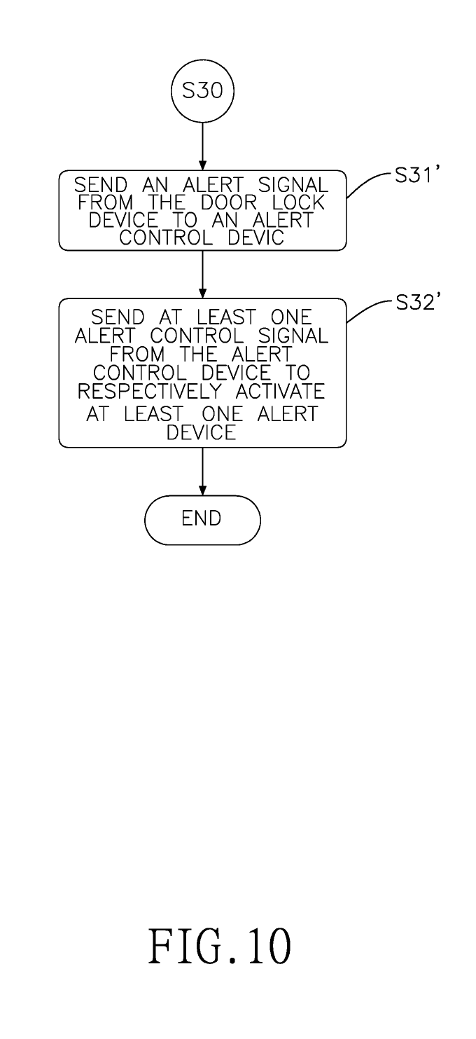

With reference to FIG. 10, the wireless door lock system may also include the alert control device 50 and the at least one alert device 60, and an embodiment of step S30 in the foregoing method further includes the following steps.

Step S31′: The door lock device 20 transmits an alert signal to the alert control device 50.

Step S32′: After receiving the alert signal, the alert control device 50 sends at least one alert control signal to respectively activate the at least one alert device 60. Thus, while the at least one recipient device 40 receives the emergency condition notification, the alert lamp, the security server or the monitor can be activated at the same time to handle the emergency condition in a more efficient, broadly covered and multi-faceted manner.

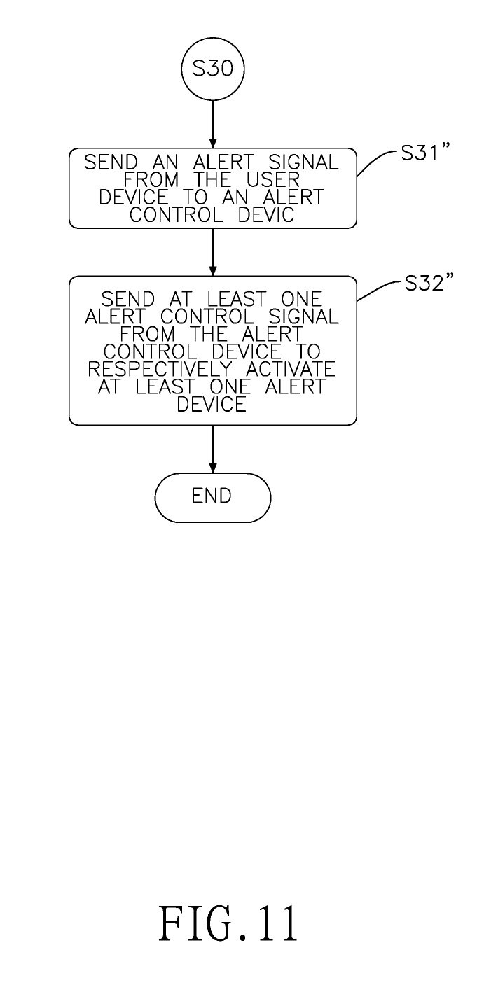

With reference to FIG. 11, another embodiment of step S30 in the foregoing method further includes the following steps.

Step S31″: The user device 10 transmits an alert signal to the alert control device 50.

Step S32″: After receiving the alert signal, the alert control device 50 sends at least one alert control signal to respectively activate the at least one alert device 60. Thus, while the at least one recipient device 40 receives the emergency condition notification, the alert lamp, the security server or the monitor can be activated at the same time to handle the emergency condition in a more efficient, broadly covered and multi-faceted manner.

In sum, the present invention has the following features and advantages.

1. In case of an emergency, persons in a dangerous situation sometimes fail to freely seek assistance for the safety concern of life and assets. Given the wireless door lock system, the persons involved can simply and intuitively press a specific physical button or select the emergency reporting function on the APP to activate the emergency condition notification in the form of text information or a display with audio and visual effects on designated recipient device(s) 40 for multiple recipients who receive the emergency condition notification to immediate action, so that the emergency condition can be obviated, the harm out of the emergency condition can be kept to a minimum, and the safety protection of life and assets of the users can be ensured.

2. The door lock device 20 transmits an emergency condition confirmation signal to the user device 20 and determine if the user device 10 is a preset paired device of the door lock device 20 according to the encrypted identification authentication information contained in the request signal, thereby achieving the function of authenticating the user device 10 and preventing non-paired user device from operating the emergency reporting function.

3. While the emergency condition notification is activated, the at least one alert device 60 can be also activated at the same time to handle the emergency condition in a more efficient, broadly covered and multi-faceted manner.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A wireless door lock system with an emergency reporting function, comprising:
a user device having a wireless data transceiving function and a wireless network connection function;
a door lock device having the wireless data transceiving function;
a network server; and
at least one recipient device having the wireless network connection function and connected to the network server through the Internet;
wherein when the user device transmits a request signal for reporting an emergency condition to the door lock device by way of wireless communication, the door lock device determines if the user device is a paired device thereof according to the request signal and then sends an emergency condition confirmation signal to the user device, and after receiving the emergency condition confirmation signal, the user device is connected to the network server through the Internet and transmits an emergency condition signal to the network server for the network server to perform a push notification server to send an emergency notification message to the at least one recipient device.

2. The wireless door lock system as claimed in claim 1, further comprising:
an alert control device connected to the door lock device by way of wireless communication; and
at least one alert device connected to the alert control device by way of wireless or wired connection;
wherein after the door lock device transmits the emergency condition confirmation signal to the user device, the door lock device sends an alert signal to the alert control device, and after receiving the alert signal, the alert control device transmits at least one alert control signal to activate the at least one alert device.

3. The wireless door lock system as claimed in claim 1, further comprising:
an alert control device connected to the door lock device by way of wireless communication; and
at least one alert device connected to the alert control device by way of wireless or wired connection;
wherein after receiving the emergency condition confirmation signal, the user device sends an alert signal to the alert control device, and after receiving the alert signal, the alert control device transmits at least one alert control signal to activate the at least one alert device.

4. The wireless door lock system as claimed in claim 1, wherein the user device has an application associated with wireless door lock operation, when the application is launched on the user device, a user interface is generated on a display screen of the user device for operation of the application, and the application provides an emergency reporting function to control the user device to send the request signal to the door lock device by way of wireless communication.

5. The wireless door lock system as claimed in claim 1, wherein the request signal contains encrypted identification authentication information, and the door lock device determines if the user device is the paired device thereof according to the encrypted identification authentication information.

6. The wireless door lock system as claimed in claim 2, wherein the at least one alert device is one or a combination of an alert lamp, a security server and a monitor.

7. The wireless door lock system as claimed in claim 3, wherein the at least one alert device is one or a combination of an alert lamp, a security server and a monitor.

8. The wireless door lock system as claimed in claim 1, wherein the wireless data transceiving function is a Bluetooth® data transceiving function.

9. A method for operating a wireless door lock system with an emergency reporting function performing an application on a user device, communicating with a door lock device with a wireless transceiving function by way of wireless communication, and connected to a network server through the Internet for the network server to perform a push notification service to send an emergency notification message to at least one recipient device, wherein the method comprises steps of:
sending a request signal for reporting an emergency condition from the user device to the door lock device;
after the door lock device receives the request signal, determining if the user device is a preset paired device of the door lock device according to the request signal;
sending an emergency condition confirmation signal from the door lock device to the user device when the door lock device determines that the user device is a paired device of the door lock device;
after the user device receives the emergency condition confirmation signal, making connection to the network server through the Internet and sending out an emergency condition signal; and
after the network server receives the emergency condition signal, performing a push notification service to send an emergency condition notification to the at least one recipient device.

10. The method as claimed in claim 9, wherein after sending the emergency condition confirmation signal to the user device, the method further comprises steps of:
sending an alert signal from the door lock device to an alert control device; and
sending at least one alert control signal from the alert control device to respectively activate at least one alert device.

11. The method as claimed in claim 9, wherein after sending the emergency condition confirmation signal to the user device, the method further comprises steps of:
sending an alert signal from the user device to an alert control device; and
sending at least one alert control signal from the alert control device to respectively activate at least one alert device.

12. The method as claimed in claim 9, wherein the request signal contains encrypted identification authentication information, and the door lock device determines if the user device is the paired device thereof according to the encrypted identification authentication information.

13. The method as claimed in claim 9, wherein the wireless data transceiving function is a Bluetooth® data transceiving function.
